(19) United States
(12) Patent Application Publication
(10) Pub. No.: US 2022/0114527 A1
(43) Pub. Date: Apr. 14, 2022

(54) SYSTEMS AND METHOD FOR COMMON APPLICATION PLATFORM

(71) Applicant: WNDYR, Inc., Dallas, TX (US)

(72) Inventors: Claire HAIDAR, Dallas, TX (US); Jeffrey HASKOVEC, Dallas, TX (US); Corby STOLCPART, Firth, NB (US)

(21) Appl. No.: 17/495,302

(22) Filed: Oct. 6, 2021

Related U.S. Application Data
(60) Provisional application No. 63/089,037, filed on Oct. 8, 2020.

(51) Int. Cl. G06Q 10/06; G06F 11/34

(52) U.S. Cl. CPC G06Q 10/06395; G06F 11/3438; G06Q 10/063114

(57) ABSTRACT

The technology described herein relates to, among other aspects, a system for connecting multiple applications and extracting work related data from these applications. The technology further harmonizes and transforms the work related data into a common model that operates across different disparate systems. In doing so, the technology can manage a digital footprint created by an individual as they work across multiple applications (e.g., Software-as-a-Service (SaaS) cloud applications).

### BACKGROUND AND SUMMARY

Technology today is so widespread that most people are immersed within some aspect of it nearly every minute of every hour in every day. Software applications play a major role in modern technology and are integrated into almost every facet of life. A typical smartphone may have dozens of applications installed and running on it alone. Likewise, an employee workstation may run a variety of software applications for conducting their work. For example, many employee workstations may use an email client for sending/receiving emails, an “office” application for generating documents, spreadsheets, and/or presentations, and a video conferencing application for conducting video conferences, among many other applications. Moreover, many software applications used in corporate settings employ cloud-based architectures thus reducing the need for organizations to maintain various in-house server systems to run the application framework.

Technology currently exists to track employee usage of various software. However, conventional technology lacks an adequate system for monitoring and compiling worker productivity across multiple disparate software applications. Moreover, conventional technology lacks an adequate system for compiling worker productivity using these disparate applications and conveying the productivity in a meaningful manner so that an employer may be able to adequately gauge employee productivity.

The technology described herein relates to, among other aspects, a system for connecting multiple applications and extracting work related data from these applications. The technology further harmonizes and transforms the work related data into a common model that operates across different disparate systems. In doing so, the technology can manage a digital footprint created by an individual as they work across multiple applications (e.g., Software-as-a-Service (SaaS) cloud applications).

The technology described herein further relates to a system that provides dashboards serving as a software interface between the applications and databases that have models designed into them, where the models and databases provide information matching feature usage to an individual's particular work output. In addition, the technology relates to correlations between features usage, work output, and recurring behavior patterns that are indicative of where and how workflow(s) can be managed optimally. Moreover, the technology relates to output of information that enables individuals, teams, and businesses to benchmark themselves across industries with regards to technology stack commonality, usage, and optimization.

Accordingly, it will be appreciated that new and improved techniques, systems, and processes are continually sought after.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BRIEF DESCRIPTION OF THE DRAWINGS

FIG. 1 depicts a non-limiting example block diagram of a system;

FIG. 2 depicts a non-limiting example block diagram of software components included in the exemplary system;

FIG. 3A shows a non-limiting flowchart for processes carried out by the system;

FIG. 3B shows a non-limiting data file processed by the system;

FIGS. 4A and 4B show further non-limiting example block diagrams of a system;

FIGS. 5A and 5B show additional non-limiting example block diagrams associated with user interfaces of the system;

FIGS. 6A-F show non-limiting example user interfaces associated with the system; and

FIG. 7 shows a non-limiting example block diagram of hardware components comprising the system shown in FIG. 2.

### DETAILED DESCRIPTION OF THE TECHNOLOGY

### Selected Definitions

When it is described in this document that an action “may,” “can,” or “could” be performed, that a feature or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, component, attribute, etc. is present in at least one embodiment, though is not necessarily present in all embodiments.

As used in this document, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage.

As used in this document, the term “and/or” includes any and all combinations of one or more of the associated listed items.

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

### Overview

The technology described herein relates to, among other topics, a system for connecting multiple applications (e.g., cloud applications) and generating a common model across disparate systems of these applications. More specifically, the technology relates to extracting work related data from these applications and transforming the data into a common model where information related to the common model can be conveyed via a user interface.

With current workflow management system technology, employee tracking and cloud application management have mostly been approached as three disparate fields with little overlap. In general, workflow management systems (WFMS) has largely been confined to production (or production-like) environments where output is generated from static processes that can be predefined. The human component within this workflow can be defined and measured. For example, a product development line within a manufacturing company has a number of processes (e.g., forming a car chassis, connecting car body to chassis, painting body of car). Some of these processes are automated and do not require human intervention, whereas some of these processes cannot be automated and require human intervention to perform the task. Through various forms of testing and optimization, the most productive flow can be determined, implemented, and measured.

Employee tracking systems may integrate into certain WFMS, but the employee tracking systems may be managed from separate applications. An employee may “clock in” and “clock out” in a given workday and throughout the workday, various applications monitor and/or track worker output. Applications monitoring and/or tracking the worker output range from time-keeping systems to actual output measurement systems.

Cloud application management has emerged as a necessary Information Technology (IT) function as multiple cloud applications are used daily by individuals. These cloud applications are rarely purchased through a centralized IT function and are therefore “undocumented” and “unmanaged” by the central IT function. Thus, an organization may be exposed to risks that need to be managed closely.

As knowledge work increases and more work is produced within disparate cloud applications (e.g., at a greater volume), a unified view of an individual's work is no longer available but is increasingly becoming critical for various reasons. In particular, operational optimization needs to occur at this level to maintain organizational health. Moreover, data management in a personal capacity is becoming increasingly important which means that data tracking needs to be in place as the foundation to the managerial activities.

Currently, outside of system settings inside individual cloud applications, an individual can exercise very little control over their own data. Proactively managing an individual data footprint is not practically possible, without extreme gathering and manipulation of raw data within each single system where an individual is working.

Thus, a need exists for a system that can track, extract, collate, and present a data footprint to an individual (e.g., for the purpose of proactive management). Furthermore, a need exists for a system which allows data to become useful for increasing productivity so that an individual's performance is directly tied to work output and not a biased perception of managers or colleagues. A need also exists for the individual's data to be collectively measured at team and organization level to maximize efficiency and profitability for an organization as a whole.

The technology described herein improves upon drawbacks in conventional technology, in part, by providing a system that correlates work output inside cloud applications to an individual (e.g., to increase overall productivity). In one non-limiting example, the technology includes a user interface enabling a user (e.g., an individual worker, a manager, an executive) to retrieve information from separate systems using a single interface. Data from the disparate applications is extracted and work related data may be compiled and stored in different database(s) that include common areas across multiple disciplines. For example, the data may be stored in databases related to common task data, document model data, communication model data, time model data, and/or meeting model data. In doing so, a common model may be generated thus allowing the system to harmonize the data in a meaningful manner that can convey different aspects of worker productivity. In certain example embodiments, the common model may include various scoring related to worker activity and productivity and such information can be conveyed via a user interface.

The user interface thus advantageously creates a prioritization mechanism for the user which enables them to focus on work that is most critical at a given time. Moreover, the technology advantageously enables a user the ability to review work retrospectively to understand behavioral patterns, while the above-mentioned scoring may be presented to the user. In doing so, the technology can lead to behavior change as the user is enabled to change the way they are engaging with systems to alter their scoring, while the scoring can act as a “nudge” for user(s) as to what items may need to be completed. It should be appreciated that the term “score” or “scoring” in this document can refer to an actual score (e.g., an alpha, numeric, and/or alphanumeric value), or can refer to any type of performance metric associated with the individual (e.g., bar graph, line graph, text).

In many places in this document, software modules and actions performed by software modules are described. This is done for ease of description; it should be understood that, whenever it is described in this document that a software module performs any action, the action is in actuality performed by underlying hardware components (such as a processor and a memory) according to the instructions and data that comprise the software module.

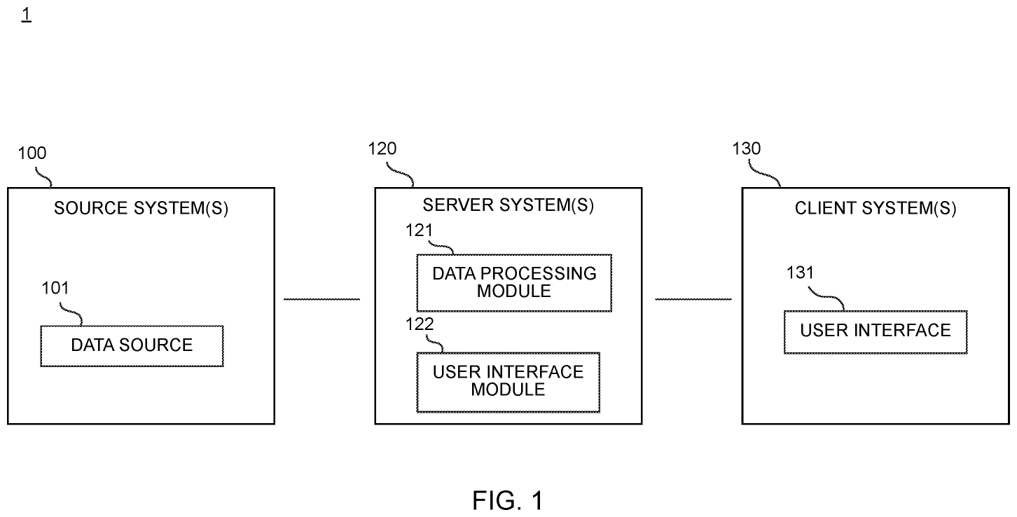

FIG. 1 shows a non-limiting example diagram of a system 1 in which data related to application use and/or worker productivity is communicated. In one non-limiting example, a server system(s) 120 can obtain data from source system(s) 100. The data obtained from the source system(s) 100 can include data related to application usage of at least one user. In one non-limiting example, source system(s) 100 can include data source 101 having data associated with, for example, application use that can be communicated to server system(s) 120. In particular, data source 101 can include information related to one or more applications associated with source system(s) 100.

Source system(s) 100 may include one or more systems containing data (e.g., in data source 101) associated with user application usage. For example, source system(s) 100 could include one or more server systems storing data associated application usage on different client devices. Source system(s) 100 could also include a user desktop terminal that uses one or more different software applications (e.g., an email application, a word processing application, a calendar application, a video conference application). As explained above, data source 101 can include data associated with each of the different software applications. In one example, data source 101 can include data files having certain metadata associated with the different applications where server system(s) 120 can obtain the metadata from source system(s) 100 and process the metadata to obtain certain information. As a non-limiting example, data source 101 can include one or more JavaScript Object Notation (JSON) files that include one or more data objects associated with different attributes related to the software applications. The use of JSON files is, of course, non-limiting and the technology described herein envisions any variety of data files with different data formats for communicating information related to application use. For example, source system(s) 100 could convey such information in an Extensible Markup Language (XML) file, a comma delimited file, and/or a flat file, among other formats.

Server system(s) 120 can receive/obtain data (from data source 101) communicated from source system(s) 100 and can process the data in accordance with the various processes described herein. In one example embodiment, data processing module 121 can receive JSON files from source system(s) 100 and can parse data objects in the JSON files for relevant data. For example, data processing module 121 can process data from a JSON file related to a video conferencing application to determine if a user has conducted video conferences, and determine the different dates/times the user conducted the video conferences. These examples are of course non-limiting and any variety of data can be parsed and extracted from the data files.

Server system(s) 120 can process data received from source system(s) 100 and use the data to convey information related to, for example, worker productivity. In one example, server system(s) 120 can generate user interface data for rendering a user interface related to such information. For example, user interface module 122 of system(s) 120 can be used to generate data for rendering a web page application at a client system(s) 130. User interface module 122 of server system(s) 120 can generate user interface data that can be communicated to client system(s) 130 where user interface 131 of client system(s) 130 can utilize the user interface data to render, for display, the user interface. For example, user interface 131 can render one or more pages of a web-site for displaying the user interface where a user can interact with objects on the one or more pages. Certain aspects related to processing the above-mentioned data received from source system(s) 100 and for generating the user interface with client system(s) 130 is discussed in further detail herein.

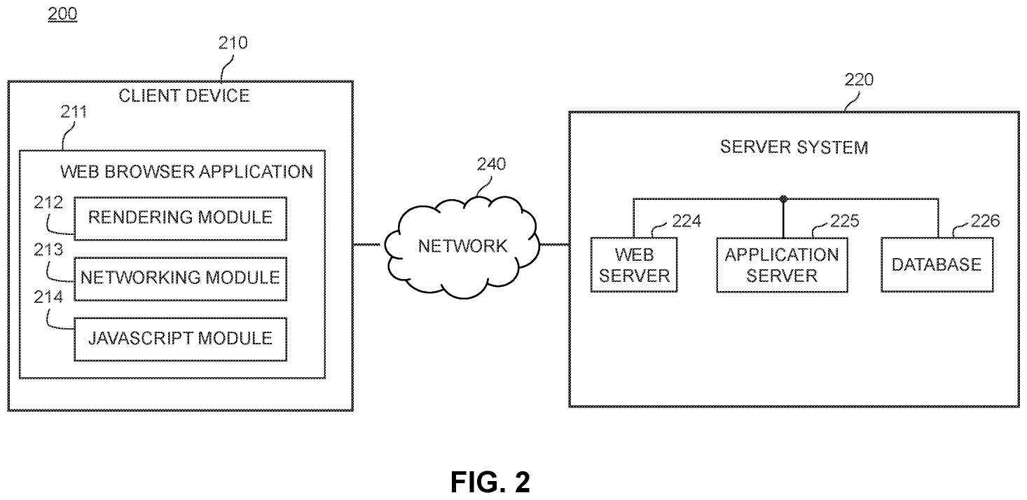

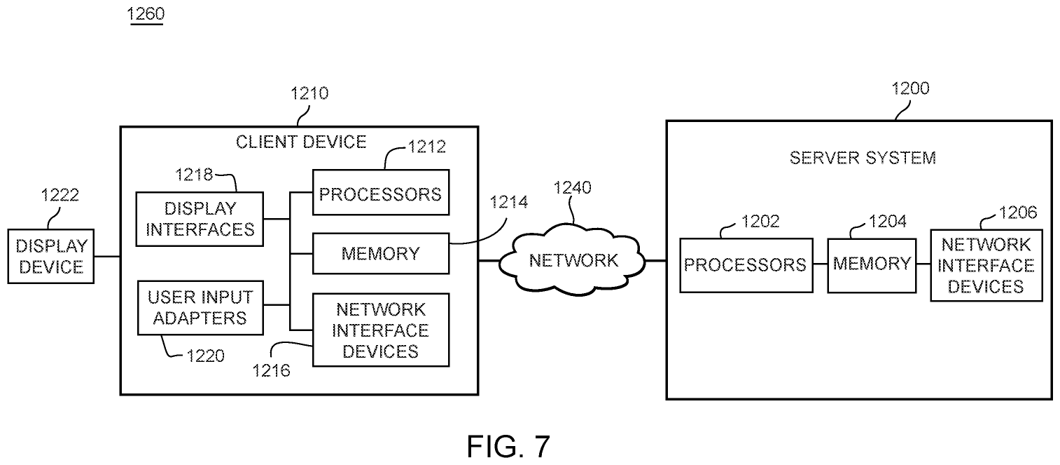

FIG. 2 shows a non-limiting example diagram of a system 200 wherein the application architecture may be implemented. As will be described below, one or more web applications defined according to the application architecture can be deployed in the system 200, and the various components in the system 200 (such as the client system 210 and server system 220) can perform different functions related to the deployed web applications. As will be discussed below, FIG. 2 shows primarily software modules (such as the web browser application 211) that run at the client system 210 and server system 220; details regarding example hardware components that may be used to execute these software modules are provided below with reference to FIG. 7, as well as in other places in this document.

In the example shown in FIG. 2, the client system 210 can communicate with a server system 220 (e.g., via a network 240). It should be appreciated that the network 240 could comprise a network of interconnected computing devices, such as the Internet. The network 240 could also comprise a local area network (LAN) or could comprise a peer-to-peer connection between the client system 210 and the server system 220.

The server system 220 can include a web server 224 that performs functionality such as implementing the HTTP protocol and communicating with the web browser application 211 (described in further detail below) in the client system 210 via HTTP. The server system 220 can also include an application server 225 that can, for example, execute server-side (or “back end”) instructions for applications implemented according to the architecture. The server system 220 can also include a database 226 that manages the persistent storage of data that is used at the server system 220. The database 226 may be or include one or more of: a relational database management system (RDBMS); an object-oriented database management system (OODBMS); an object-relational database management system (ORDBMS); a not-only structured query language (NoSQL) data store; an object cache; a distributed file system; a data cluster (based on technology such as Hadoop); and/or any other appropriate type of data storage system.

The client system 210 can include software components for performing processing related to applications defined according to the described system. As a non-limiting example, the client system 210 may have a web browser application 211 consisting of, at least, a rendering module 212, a networking module 213 and a JavaScript module 214. Of course, these modules are a non-limiting example, and the application 211 can comprise several more modules and/or different modules than those shown in FIG. 2.

The rendering module 212 can implement functionality for the graphical display and rendering of web page user interfaces. It can, for example, generate graphical data that corresponds to the HTML and/or DOM that defines a web page processed by the web browser application 211; this graphical data can, potentially after further modification/transformation by the operating system of the client system 210, be displayed on a display of the client system 210. Alternatively or additionally, whenever it is described in this document that the client system 210 renders/displays a web page, the rendering/displaying module 212 may perform functionality related to the rendering/display of the web page.

The networking module 213 can implement the HTTP protocol, and be used to handle various HTTP messages between the client system 210 and the web server 204 in the server system 200. Alternatively or additionally, whenever it is described in this document that the client system 210 communicates using HTTP, the networking module 213 may handle the HTTP aspects of such communications.

The JavaScript module 214 can be used to execute JavaScript scripts, manipulate JavaScript objects, modify the DOMs of web pages loaded at the web browser application 211, and perform other functionality related to JavaScript. The JavaScript module may be, for example, a JavaScript engine, a JavaScript virtual machine, a JavaScript runtime, or any other type of software module capable of executing JavaScript instructions. Alternatively or additionally, whenever it is described in this document that the client system 210 performs functionality related to JavaScript, such functionality may be handled by the JavaScript module 214.

It should be appreciated that while the diagram in FIG. 2 shows the components existing within a single system, the components could be incorporated in multiple systems and/or a distributed computing environment (e.g., a cloud computing environment). Thus, the processing system 200 is not limited to a single component and can be incorporated into multiple components.

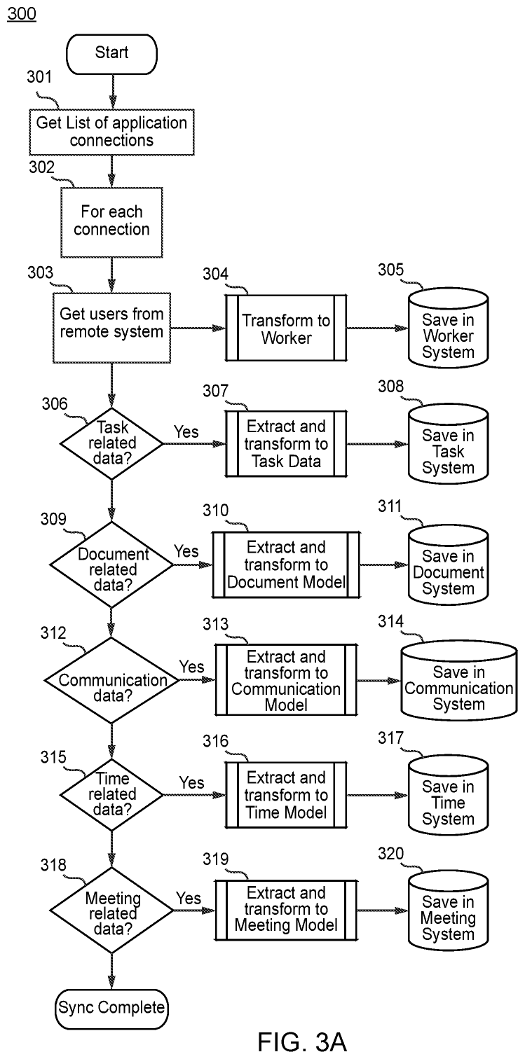

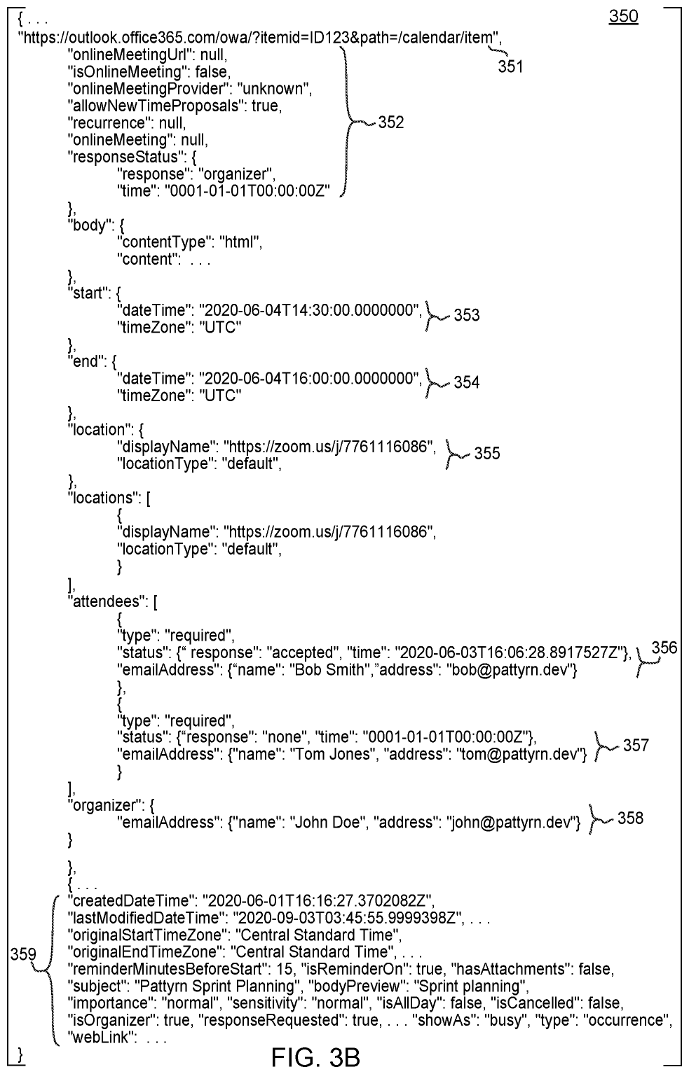

FIG. 3A shows a non-limiting example flowchart related to obtaining data related to application usage and processing the data according to different models. The process described in FIG. 3A could include data processing in accordance with the data communicated between source system(s) 100 and server system(s) 120. In particular, the process depicted in FIG. 3A could relate to processing carried out by server system(s) 120 in obtaining and processing data from source system(s) 100 in system 1.

The process begins where system(s) 120 can obtain a list of application connections (action 301). In one non-limiting example, system(s) 120 can interface with different source system(s) 100 associated with different application(s) (e.g., cloud based applications). System(s) 120 may interface with different systems containing data for a particular cloud application, as a non-limiting example. For example, server system(s) 120 may communicate with a system containing source data related to a video conferencing application. Server system(s) 120 may also communicate with a system containing source data related to an email/calendar application.

For each connection related to the application (action 302), system 1 can obtain user data from the source system(s) 100 (action 303). In one non-limiting example, system 1 can obtain user data in order to generate a “worker” profile for a user. As an example, a user “Jane Smith” could use a variety of application in which the system is obtaining data, and by parsing, extracting, and/or analyzing certain user data (e.g., full name of the user, email address), the system can create a single “worker” to which the user using these applications is associated. In doing so, system 1 can transform the user data to a “worker” (action 304) and save the same in a database memory of the system 1 (action 305).

At actions 306-320, the system 1 can parse, extract, and analyze further data obtained from source system(s) 100 and determine if the data falls within different work models. For example, system 1 can determine if the obtained data includes information that could fall into different models associated with worker productivity and/or application usage. In one example, system 1 can parse the obtained data into five different models where each model may correspond to how a user is working/operating within an organization. Of course, this example is non-limiting and the technology described herein envisions any different number of models.

The system 1 may first determine if the data includes task related data (action 306) in which the data will be extracted and transformed into task data (action 307) and stored in a database memory of the system 1 (action 308). As an example, the system may parse different objects from a JSON file to determine if certain elements in the file include data related to a task of a worker. For example, data from a task management application may include different tasks that an employee must work on and complete. The elements in the JSON file may include whether the task has been assigned, is in progress, or is complete, among other examples. The task data can be associated with the user and stored in a database of the system where the system can analyze the associated task data to help gauge productivity of the particular user. As an example, and as discussed herein, the system may generate a score associated with the task data and that score will then be associated with the particular user.

The system 1 may further determine if the data includes information related to document related data (action 309) in which the data will be extracted and transformed into document model data (action 310) and stored in a database memory of the system 1 (action 311). As another example, data from a word processing application may be obtained by system 1 (e.g., in one or more JSON files) where the data may include information associated with documents in which the user has worked. For example, a user may be working on a particular document (e.g., with other users) where information related to worker contribution on the document (e.g., number of paragraphs written, number and type of changes made, amount of time accessing document) can be associated with the user and stored in the system. Similar to the task data, the system can generate a score associated with the document model data and that score will be associated with the user.

The system 1 may further determine if the data includes information related to communication data (action 312) in which the data will be extracted and transformed into communication model data (action 313) and stored in a database memory of the system 1 (action 314). As a further example, data from an email application may be obtained by system 1 where the data may include information associated with communications between user and other users. For example, system 1 may obtain information related to the number of emails, amount of information contained in the emails (e.g., length of the emails), and/or the number of people in which the user emails, and associate such information with the user as communication model data. The system 1 can generate a score associated with the communication model data and that score will be associated with the user.

The system 1 may further determine if the data includes information related to time model data (action 315) in which the data will be extracted and transformed into time model data (action 316) and stored in a database memory of the system 1 (action 317). As another example, data from a time management application may be obtained by the system 1 where the time management application may include information as to how the user is working on projects over a period of time. For example, the time management application could include the number of hours a user has entered as working on a particular project and such information could be associated with the time model data. The system 1 can generate a score associated with the time model data and that score will be associated with the user.

The system 1 may further determine if the data includes information related to meeting related data (action 318) in which the data will be extracted and transformed into meeting model data (action 319) and stored in a database memory of the system 1 (action 320). As a further example, data from a calendar and/or video conferencing application may be obtained by the system 1 where such information may include elements associated with the user participation in various meetings. For example, the data may include information related to a number of meetings the user participates, a duration of time spent in the meetings, and/or information as to whether the user is a host of the meetings, and such information could be associated with the meeting model. The system 1 can generate a score associated with the meeting model data and that score will be associated with the user. It should be appreciated that the system 1 may generate a score associated with each model and such information could be individually conveyed to a user (e.g., via the user interface). Likewise, the score information may be combined into a composite score and conveyed via the user interface.

It should be further appreciated that the “score” that is generated may be conveyed in a variety of manners. In one non-limiting example, the “score” can be conveyed via a numeric, alpha, and/or alphanumeric indication (e.g., via user interface 600). The “score” may also be conveyed in any variety of manner including, but not limited to, different graphs (e.g., bar, line, circle), text data, and/or call-to-action items (discussed herein). That is, the “score” may not be a strict value, but can be shown using a variety of different components in the user interface 600 to depict individual and/or group productivity.

It should be understood that, although actions 301-320 are described above as separate actions with a given order, this is done for ease of description. It should be understood that, in various embodiments, the above-mentioned actions may be performed in various orders; alternatively or additionally, portions of the above-described actions 301-320 may be interleaved and/or performed concurrently with portions of the other actions 301-320.

FIG. 3B shows a non-limiting example data file 350 including elements/objects associated with application usage. In the example shown in FIG. 3B, the data objects are contained within a JSON file where the JSON file may include a plurality of different objects associated with one or more applications. The system 1 is capable of parsing the elements in the data file 350 to extract and process data associated with user application usage for one or more applications. The elements extracted from data file 350 can be used to populate data associated with the different worker models described herein, as a non-limiting example.

Data file 350 includes an application identification 351 containing information identifying a specific application. In the example of FIG. 3B, application identification 351 includes information identifying a calendar item in an office productivity suite. Application identification 351 could include identification information relating to a variety of different applications including, but not limited to, video conferencing applications, messaging applications, social media applications, and/or email applications, among other applications.

Data file 350 further includes a variety of data elements associated with the application identified by application identification 351. In the example of FIG. 3B, the elements specifically relate to a calendar application and thus the specific elements identified in FIG. 3B are associated with data objects in a calendar application. It should be appreciated that such data objects may change based on the application type and thus the elements shown in FIG. 3B are non-limiting.

In the example of FIG. 3B, data file 350 can further include initial meeting information 352. Initial meeting information 352 may include information related to basic information associated with the meeting, as a whole. For example, initial meeting information 352 may include indications as to whether the meeting is online and can include Uniform Resource Location (URL) information associated with an online meeting. Initial meeting information 352 may further include whether a user can allow a new time proposal, whether the meeting may be recurring (e.g., daily, weekly, monthly), and/or a response status associated with the meeting invitation.

Data file 350 can further include specific details associated with a particular meeting in a calendar application. As a non-limiting example, data file 350 may further include meeting start time 353 indicating a specific date and time for the meeting to begin. Meeting start time 353 may further include a time zone associated with the meeting start time. In the example shown in FIG. 3B, meeting start time 353 includes a start date and time of Jun. 4, 2020 at 2:30 PM in Coordinate Universal Time (UTC) zone.

Data file 350 may further include meeting end time 354 indicating a specific date and time to end. Similar to meeting start time 353, meeting end time 354 may further include a time zone associated with the meeting end time. In the example shown in FIG. 3B, meeting end time 354 includes an end date and time of Jun. 4, 2020 at 4 PM (UTC). It should be appreciated that with such information, system 1 can determine that the meeting will last approximately 90 minutes (i.e., from 2:30 PM to 4 PM).

Data file 350 may further include location information 355 indicating a location of a meeting. In the example shown in FIG. 3B, location information 355 includes information for a video conferencing meeting in a “virtual” location. In particular, location information 355 identifies a link to access a virtual meeting via a video teleconference. It should be appreciated that location information 355 could include a virtual location as well as a physical location (e.g., address for a meeting, a conference room in an office).

Data file 350 can further include information associated with different attendees of a meeting. In the example shown in FIG. 3B, data file 350 includes first attendee 356 information providing information related to a first user invited to a meeting, and second attendee 357 information related to a second user invited to a meeting. The first attendee 356 and second attendee 357 information can include information related to whether the user is required to attend (as opposed to optional attendance), information related to the status of responding to a meeting invitation (e.g., accepted, rejected, tentative, no reply), and/or identification information of the attendee (e.g., name and email address). In the example of FIG. 3B, first attendee 356 information indicates user Bob Smith with email “bob@pattyrn.dev” is required to attend the meeting, and user Bob Smith has accepted the invitation for the meeting on Jun. 3, 2020 at 4:06 PM. Similarly, second attendee 357 information indicates user Tom Jones with email “tom@pattyrn.dev” has not replied to the meeting request and is also listed as a required attendee. Data file 350 can further include organizer 358 information identifying one or more organizers of the meeting. Similar to first attendee 356 and second attendee 357 information, organizer 358 information can include identification information of the organizer (e.g., name and email address), In the example of FIG. 3B, organizer 358 information identifies John Doe as the organizer having an email address of “john@pattyrn.dev.”

Data file 350 may further include additional meeting information 359 including additional details associated with the meeting. For example, additional meeting information 359 could indicate when the meeting invitation was created, a last modified date/time of the invitation, an original start and end time zone, an indication for whether a meeting reminder flag has been set and/or how much time before the meeting the reminder should activate, indication as to whether the meeting invitation contains attachments, a meeting subject, a meeting importance and/or sensitivity level, and/or an indication as to whether the meeting is flagged as being “all day,” among other items. As noted herein, the examples depicted in FIG. 3B specifically related to a calendar invite for a meeting and thus the information provided in data file 350 may include further and/or alternate information depending upon the application type.

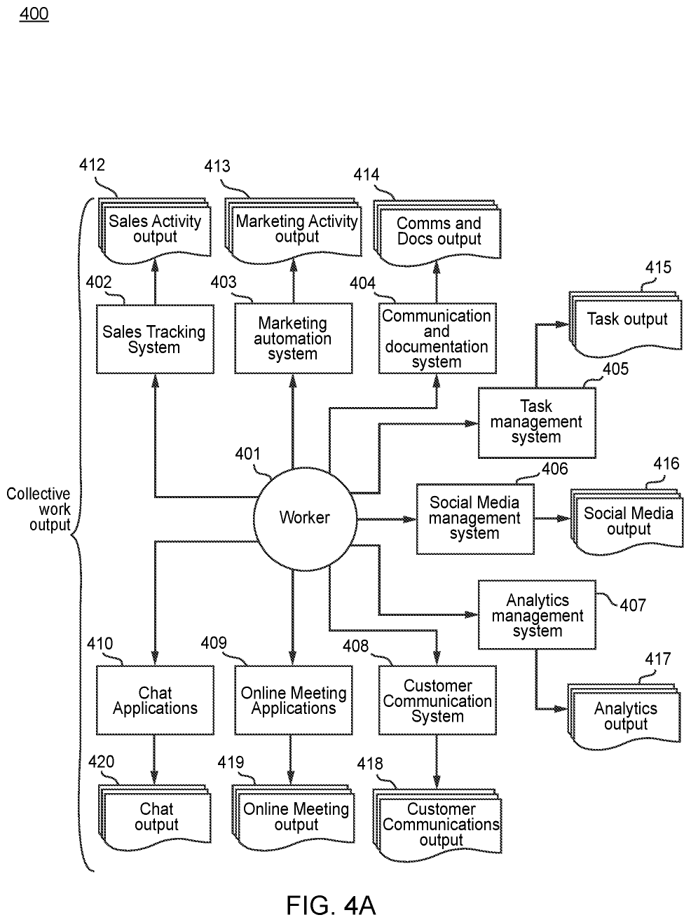

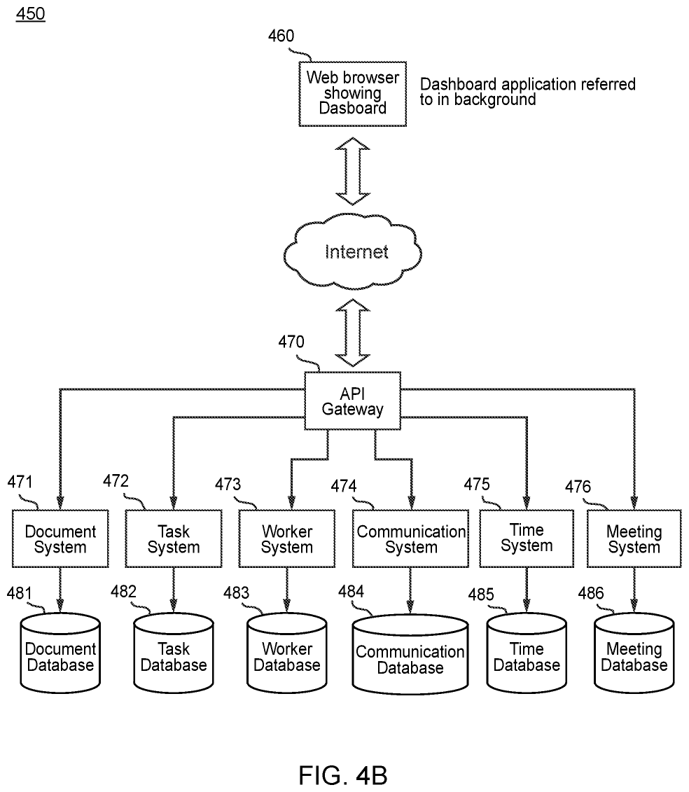

FIGS. 4A and 4B show non-limiting example block diagrams related to system 1 collection of different application usage data and processing. FIG. 4A specifically shows an example block diagram of application output model 400 for generating a “footprint” of a user across multiple different applications. While not limited to such an embodiment, FIG. 4A can particularly relate to a user operating multiple SaaS cloud applications.

As discussed herein, the system 1 can obtain data related to how a user utilizes different software applications and system 1 can harmonize the data to a specific user. FIG. 4A depicts several example applications in which a worker 401 can operate where each application can be associated with worker 401 performance. Each example application can include different output data and such information is collected by system 1 for extracting and transforming to the different work models described herein. In particular, application output model 400 can include a sales tracking system 402 generating associated sales activity output 412. In one non-limiting example, sales tracking system 402 could include Customer Relationship Management (CRM) software for connecting internal employee departments in a business organization, as well as connecting worker 401 with outside parties/customers. In particular, sales tracking system 402 could provide data related to how worker 401 is conducting sales with different clients and such information will generate sales activity output 412 usable by system 1 for assessing performance of worker 401.

Application output model 400 can further include a marketing automation system 403 that generates marketing activity output 413. Similar to sales tracking system 402, marketing automation system 403 may include CRM software having capabilities allowing worker 401 to automate various aspects related to business marketing (e.g., triggered emails, drip campaigns, lead management, digital marketing analytics). The marketing automation system 403 may provide various metrics regarding how worker 401 is engaging with current and prospective customers, as well as how worker 401 is generally advertising aspects of a business where such information will generate marketing activity output 413 usable by system 1 for assessing worker 401 performance.

Application output model 400 can further include a communications and documentation system 404 that generates communications and documents output 414. In one non-limiting example, communications and documentation system 404 can include software for tracking communications among employees and/or data documenting employee activity. The communications and documentation system 404 can include, for example, data related to managing various business communications and such information will generate communications and documentation output 414 usable by system 1 for assessing worker 401 performance.

Application output model 400 can further include a task management system 405 that generates task output 415. In one non-limiting example, task management system 405 may include a task management tool used by an individual, team, or organization to help complete projects more efficiently by organizing and prioritizing related tasks. The task management system 405 can be used to ensure components helping worker 401 organize, prioritize, and/or visualize work tasks and such information will generate task output 415 usable by system 1 for assessing worker 401 performance.

Application output model 400 can further include a social media management system 406 that generates social media output 416. In one non-limiting example, social media management system 406 can monitor worker 401 usage across one or more different social media applications. For example, social media management system 406 can monitor how active worker 401 is on social media and/or how engaged worker 401 is with other participants on social media. Social media management system 406 will thus produce social media output 416 usable by system 1 for assessing worker 401 performance.

Application output model 400 can further include analytics management system 407 that generates analytics output 417. In one non-limiting example, analytics management system 407 could include a software application for analyzing various data associated with the business using different quantitative and statistical tools to help the business make data-driven decisions. Analytics management system 407 could be used to analyze worker 401 using such tools and thus produce analytics output 417 usable by system 1 for assessing worker 401 performance.

Application output model 400 can further include customer communication system 408 that generates customer communications output 418. In one non-limiting example, customer communication system 408 could include software enabling an organization to manage customer communication across a wide range of media. Such communications could include digital documents and emails, and also include text-based messaging (e.g., Short Messaging Service (SMS)/Multimedia Message Service (MMS) messages) and messages over various social media platforms. Customer communication system 408 may generate data associated with worker 401 communicating with different customers where such information creates customer communications output 418 usable by system 1 for assessing worker 401 performance.

Application output model 400 can further include online meeting applications 409 that generates online meeting output 419. In one non-limiting example, online meeting applications 409 could include software associated with a calendar application and/or conference application for scheduling and conducting meetings involving worker 401. In particular, online meeting applications 409 could generate data related to worker 401 involvement in different online meetings (e.g., online video conferences) where such data creates online meeting output 419 usable by system 1 for assessing worker 401 performance.

Application output model 400 can further include chat applications 410 that generates chat output 420. In one non-limiting example, chat applications 410 may include software applications enabling users to generate message data communicable between systems to conduct various virtual “chats.” Chat applications 410 could generate chat output 420 associated with worker 401 message volume across various users where system 1 can use such information for assessing worker 401 performance.

In one non-limiting example, various output 412-420 can include different JSON files providing a plurality of data objects and elements as shown, for example, with respect to FIG. 3B. As discussed herein, system 1 can obtain JSON files associated with output 412-420 and process the data to associate such output with one or more different models associated with worker 401 performance.

FIG. 4B shows a non-limiting example block diagram for performance analysis system 450 where different components for measuring performance and conveying performance are shown. In one non-limiting example, performance analysis system 450 may include components associated with a “back end” process and can further include components associated with a “front end” process (e.g., user interface). The system 450 shown in FIG. 4B includes different systems 471-476 associated with a user and the respective models related to user/worker performance, as well as different databases 481-486 related to systems 471-476.

System 450 can include a document system 471 having an associated document database 481. Document system 471 may contain data and processing associated with worker performance with respect to how a worker is utilizing various software applications related to various documents. For example, document system 471 may contain information related to how a user is utilizing different word processing applications, how a user contributes to one or more documents shared within a group, how often and/or how many documents are checked in and out by a user in a document management system, and/or how active a user is involved in editing/commenting documents for other users. Such information may be harmonized by document system 471 to generate a score associated with the user involvement regarding document usage and such information can be stored and associated with the user in document database 481.

System 450 can also include task system 472 having an associated task database 482. Task system 472 may contain data and processing associated with worker performance related to how a worker utilizes different software applications for task related purposes. For example, task system 472 may contain information related to how a user is utilizing different task management applications, how much a user completes various tasks and/or how much a user completes tasks relative to a total number of tasks, and/or comparative task analysis between different users. Such information may be harmonized by task system 472 to generate a score associated with the user involvement regarding task data and such information can be stored and associated with the user in task database 482.

System 450 can also include communication system 474 having an associated communication database 484. Communication system 474 may contain data and processing associated with worker performance related to how a worker utilizes different software applications for various communications. For example, communication system 474 may contain information related to how a user is utilizing software applications for communicating email messages to individuals both internal to an organization and external to the organization, information related to user involvement in one or more different chat/messaging applications, and/or information related to user involvement in social media applications. Such information may be harmonized by communication system 474 to generate a score associated with the user involvement in various communication related activities and such information can be stored and associated with the user in communication database 484.

System 450 can also include time system 475 having an associated time database 485. Time system 475 may contain data and processing associated with worker performance related to how a worker utilizes different application involving time related purposes. For example, time system 475 may contain information related to time management. In particular, time system 475 could use data from calendar and/or video conference applications to determine how long a user spends in meetings for a particular period of time (e.g., day, week, month). Time system 475 could also use data related to how much time a user spends in different applications (e.g., document related applications, CRM systems, social media application). Such information may be harmonized by time system 475 to generate a score associated with the user involvement in various time related activities and such information can be stored and associated with the user in time database 485.

System 450 can further include meeting system 476 having an associated meeting database 486. Meeting system 476 may contain data and processing associated with a user utilizing various applications related to meeting oriented tasks. For example, meeting system 476 may contain information related to user involvement in different meetings based on information provided from a calendar application and/or a video conferencing application. Meeting system 476 may also contain information related to user involvement in different meetings based on how many (or how often) a user is sending email messages with meeting invitations. Such information may be harmonized by meeting system 476 to generate a score associated with user involvement in various meeting related activities and such information can be stored and associated with the user in meeting database 486.

System 450 may further include worker system 473 having an associated worker database 483. Worker system 473 may contain various information associated with a user where such information is stored in worker database 483. For example, worker system 473 may include various information related to a user profile (e.g., name, email address, title). Worker system 473 may further include various information related to different applications in which the user is associated and/or different profile information of the user for such applications. Worker system 473 and worker database 483 may be used to harmonize worker/user information in order to generate a single worker/user corresponding to an individual.

System 450 can include an application programming interface (API) 470 in order to utilize data associated with systems 471-476 (stored respectively in databases 481-486). In particular, API 470 may generate data associated with a user interface based on the interaction between systems 471-476. The software user interface may be communicated to client device(s) to generate dashboard 460 including one or more pages in the software user interface. Dashboard 460 may continually communicate with API 470 in order to allow a user to interact with the user interface for navigating a web application, for example.

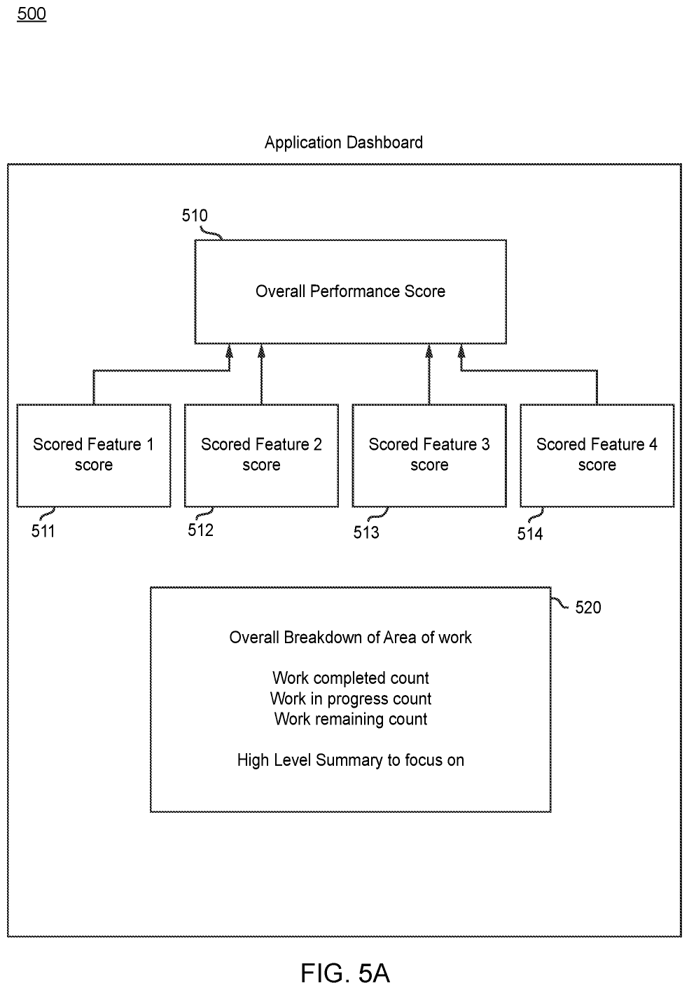

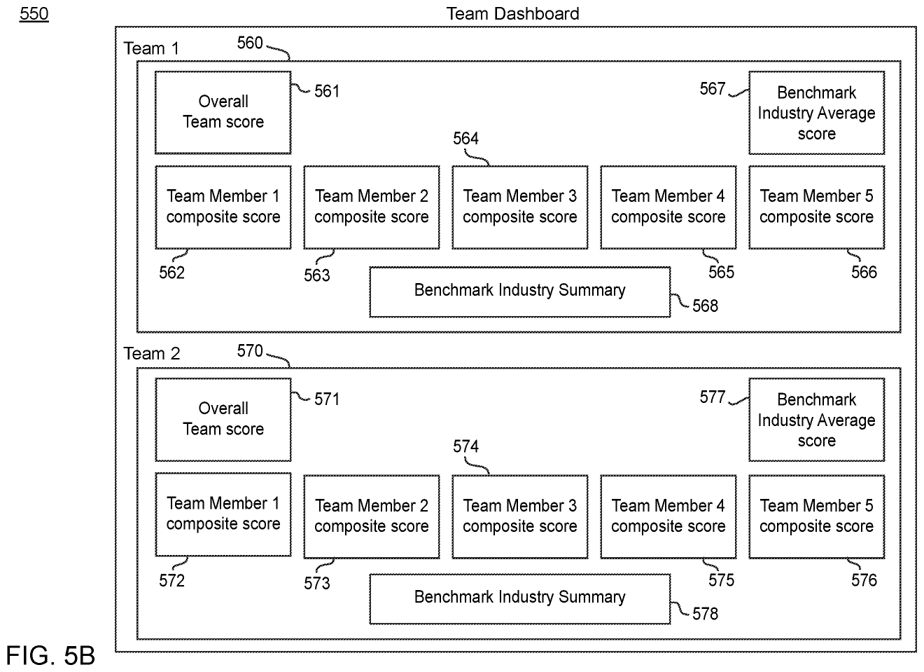

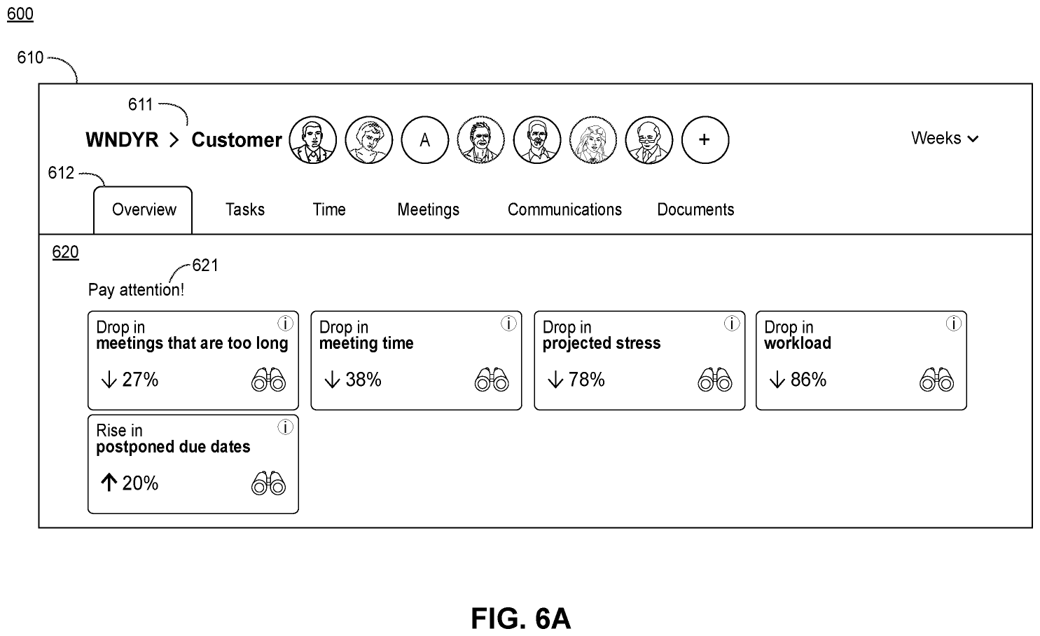

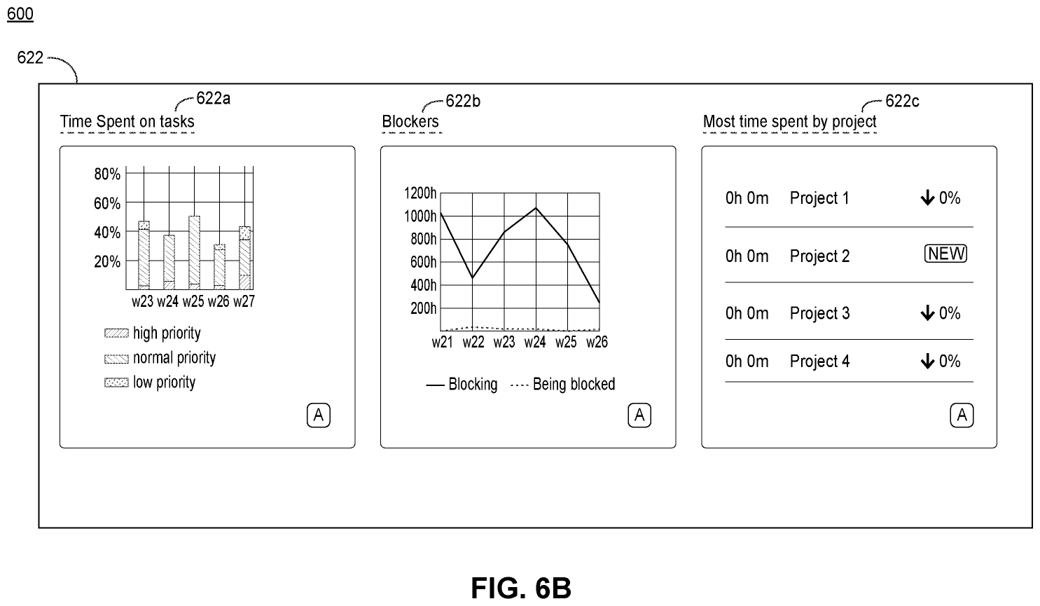

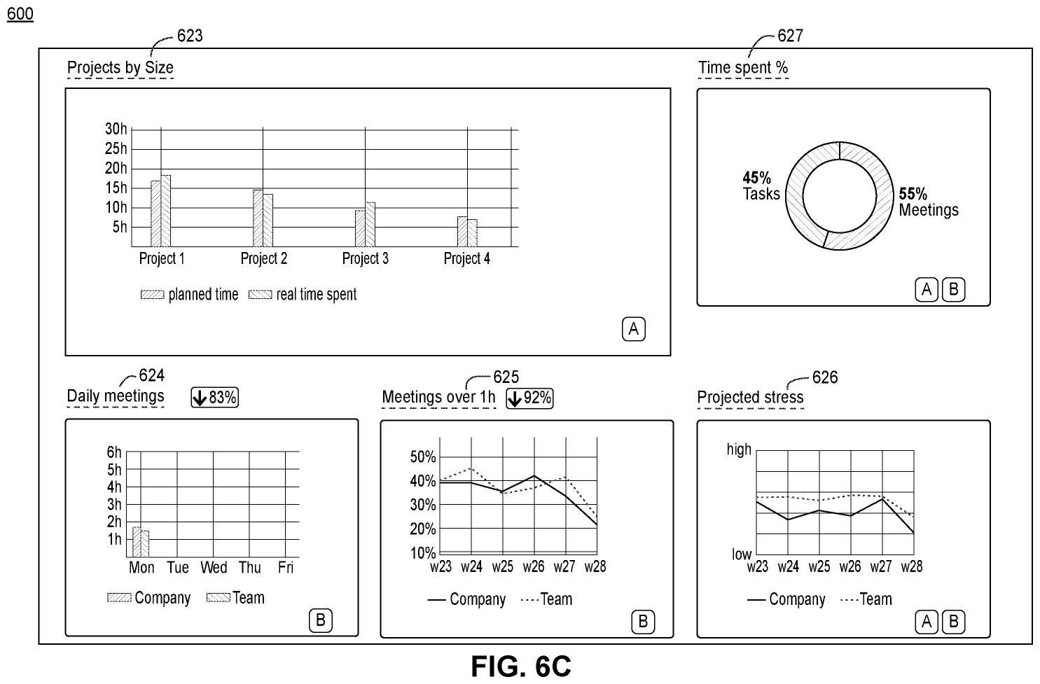

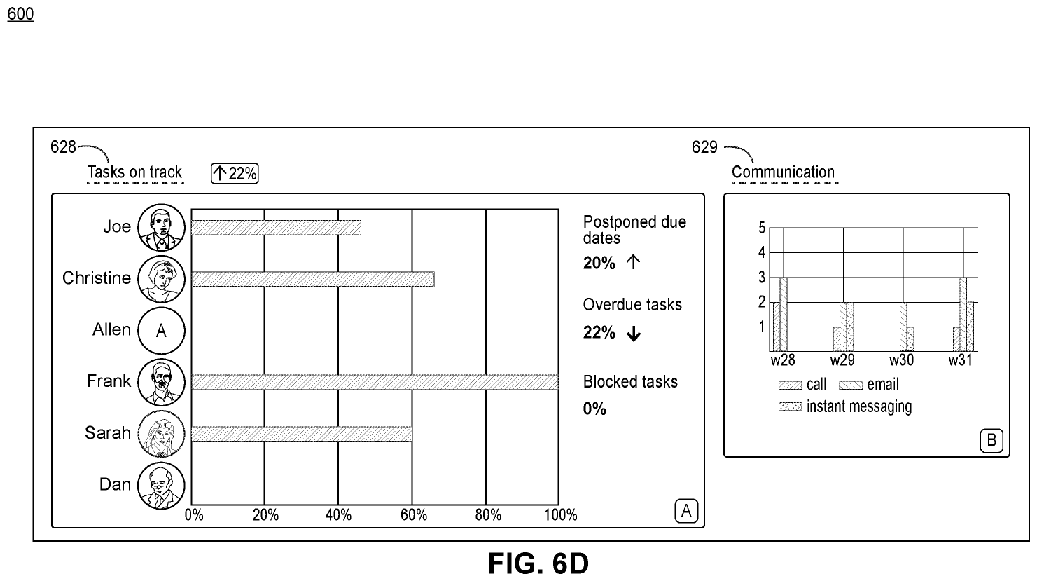

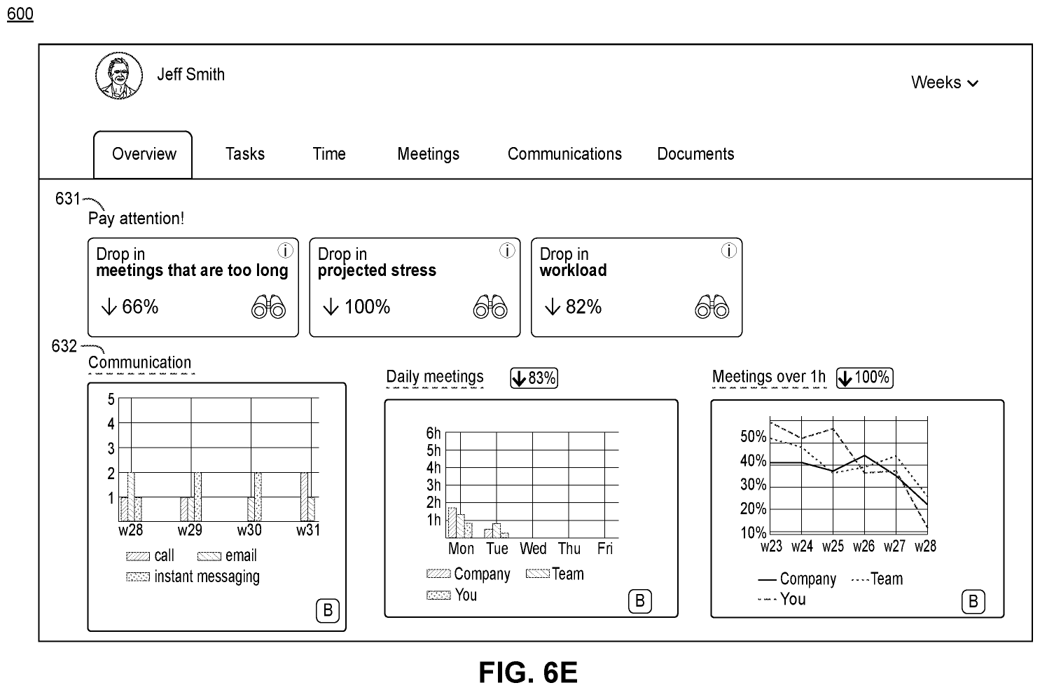

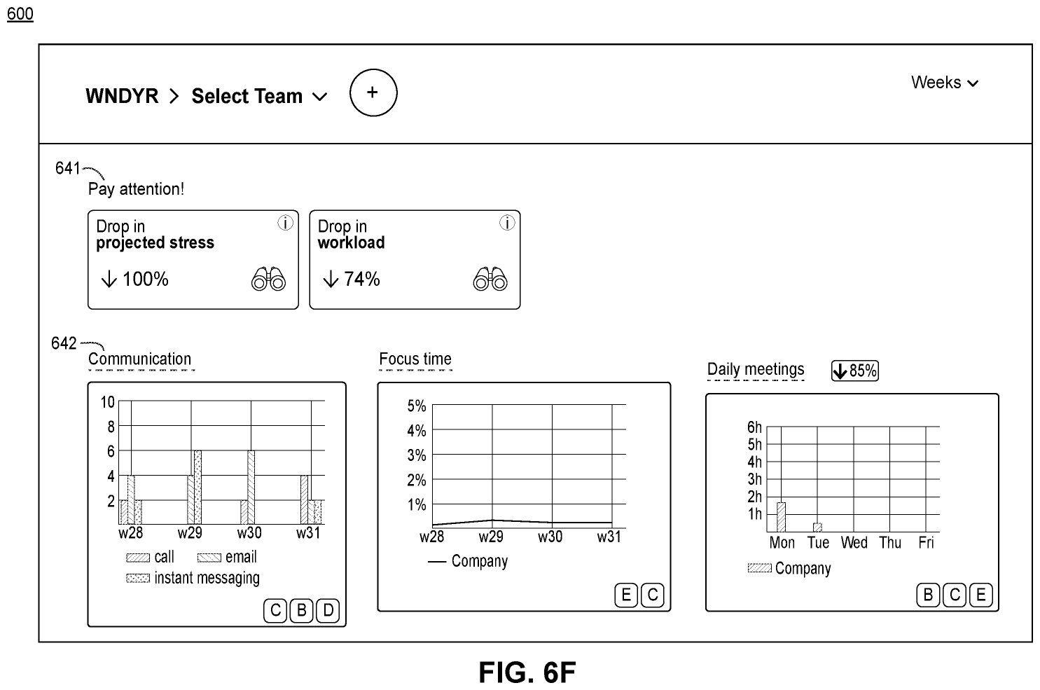

FIGS. 5A and 5B show further non-limiting example block diagrams associated with user interfaces of the system. FIG. 5A shows a non-limiting example block diagram of user interface 500 including a software “dashboard” for a particular user. The examples shown in FIGS. 5A and 5B can include illustrative embodiments of user interfaces shown with respect to FIGS. 6A-F. It should be appreciated that some of the elements discussed with respect to FIGS. 5A and 5B may not be explicitly shown in FIGS. 6A-F, but are representative examples of the user interfaces of the disclosed technology.

In the example shown in FIG. 5A, user interface 500 includes indications related to performance/scoring of a user as well as various details regarding performance. In an example embodiment, user interface 500 includes an overall performance score 510 including a portion on user interface 500 for conveying score associated with overall user performance. In particular, overall performance score 510 could include a single (e.g., composite) score related to individual feature scores 511-514. For example, feature scores 511-514 could include individual scores associated with different models (e.g., document model, time model, communications model) described herein, where overall performance score 510 may include a single/combined score related to features scores 511-514 for the different models described herein.

User interface 500 may further include scoring details 520 including a “breakdown” of how scores 510-514 are generated. In one non-limiting example, scoring details 520 could include information related to tasks associated with the user and how the user has progressed and/or completed certain tasks.

FIG. 5B shows a non-limiting example block diagram of user interface 550 including a software “dashboard” for a team of users. In the example shown in FIG. 5B, user interface 550 can include first team area 560 and second team area 570. Each of first team area 560 and second team area 570 can include information related to different aspects of scoring for the team and the associated team members.

In more detail, first team area 560 can include individual team member scoring areas 562-566 representing individual scores associated with each team member performance. In one non-limiting example, individual team member scores may include combined/composite scores associated with the team member and such information may be conveyed via team member scoring areas 562-566 of user interface 550.

First team area 560 may further include an overall team score 561. Overall team score 561 may include a combination of scoring from individual team member scores associated with team member scoring areas 562-566. In one non-limiting example, overall team score 561 may simply include an accumulation of scores 562-566, or overall team score 561 may include a composite score related to individual team member scores. First team area 560 may further include a benchmark score 567 and benchmark summary 568 associated with various benchmarks related to team and individual performance. For example, benchmark score 567 could correlate to a scoring for similarly comprised teams based on a benchmark industry standard. Benchmark summary 568 could include summary level information related to the benchmark industry standard associated with benchmark score 567. Benchmark summary 568 could include, for example, various information related to tasks associated with the user team and how the user team has progressed and/or completed certain tasks compared to a benchmark industry standard.

Second team area 570 can include similar components to that of first team area 560. In particular, second team area 570 can also include an overall team score area 571 associated with team member scoring areas 572-576. Likewise, second team area 570 can also include a benchmark score 577 and a benchmark summary 578 associated with benchmark performance relative to the team.

FIGS. 6A-F show non-limiting example user interface(s) 600 generated by system 1. In one non-limiting example, user interface(s) 600 (hereinafter referred to as user interface 600) can be generated by system 1 and transmitted as data packets to one or more client devices (e.g., client device 210) where client devices can use the data packets to render the user interface 600. The user interface 600 shown in FIGS. 6A-F can, in non-limiting example embodiments, convey information related to worker productivity including worker scoring.

FIG. 6A shows a non-limiting example user interface 600 depicting a team (or manager) view associated with a team of employees and the respective worker productivity of the team. It should be appreciated that user interface 600 can display any variety of views (discussed in further detail herein) that include any of a team view, an individual view, a company view, and/or an industry view. In one non-limiting example, user interface 600 may be configured so that a user can drill between an individual view, a team view, a company view, and an industry view in an upward/downward fashion. For example, a user could be viewing an individual view but then drill “upward” to a team view. Likewise, a user could be viewing a company view but drill “downward” to a team view. Moreover, it should be appreciated that user interface 600 can show various elements over different time scales. For example, user interface 600 can show elements over a day time scale, week time scale, month time scale, and/or year time scale.

User interface 600 (as shown in the example of FIG. 6A) can include a header portion 610 and body portion 620. The header portion 610 can include various header data for navigating different aspects of the user interface 600. For example, header portion 610 can include view selection 611 for selecting different views of the user interface 600. For example, view selection 611 can enable switching between the different views discussed herein (e.g., individual view, team view, company view, industry view). In the example of FIG. 6A, the team view is currently selected and thus the information shown in user interface 600 corresponds to a particular team. Header portion 610 can also include selectable tabs 612 for switching between different elements displayed in body portion 620. For example, selectable tabs 612 could include an overview tab, tasks tab, time tab, meetings tab, communications tab, and documents tab. Selection of each tab from selectable tabs 612 can cause user interface 600 to modify the content shown in body portion 620. In the example shown in FIG. 6A, “overview” tab is selected in the selectable tabs 612 and thus overview information for is shown in body portion 620.

In more detail, body portion 620 includes various overview elements 621 depicted in the example of FIG. 6A. In one non-limiting example, the overview elements 621 may be considered “call to action” items alerting a user of the most relevant items needing attention. In the example of FIG. 6A, overview elements 621 include different rectangular objects having different overview “snippets” associated with productivity. Overview elements 621 could include indications as to how productivity has risen (or dropped) during a particular time scale. That is, system 1 can collect metrics over time to give context of various action items over a particular time scale. As a non-limiting example, overview elements 621 could include a rectangular object indicating a “drop in meetings that are too long” along with a graphical indicator (e.g., “down arrow,” “up arrow”) and a percentage associated with the rise or drop in productivity. FIG. 6A shows additional rectangular objects associated with a rise or decline in meeting time, projected stress, workload, and postponed due dates. It should be appreciated that these examples are of course non-limiting and the technology described herein envisions any variety of objects that could be displayed in association with overview elements 621.

FIG. 6B shows another non-limiting example user interface 600 showing further details associated with the team view. In the example of FIG. 6B, user interface 600 includes different information in body portion 620 that includes information associated with the different work models (discussed herein). In one non-limiting example, user interface 600 shown in FIG. 6B can show information related to work productivity associated with tasks and/or time for a team of employees. In one non-limiting example, user interface 600 can include task elements 622 that contain information associated with worker productivity by task and/or time.

In the example shown in FIG. 6B, task elements 622 could include graphical objects that show different metrics associated with productivity of one or more employees based on task data associated with the employees. For example, task elements 622 can include task element graph 622a having a graphical object associated with time spent on different tasks. Task element graph 622a can include a bar graph showing a percentage along one axis and a time unit along another axis. Task element graph 622a can include an indication of priority along with different bars in the bar graph showing a percentage during each week that is dedicated to tasks of different priority. In the example of FIG. 6B, task element graph 622a shows a bar associated with week 28 (“wk28”) at approximately 80% where a substantial portion of the bar is associated with “normal priority” tasks where a small portion of the bar is associated with “high priority” tasks. It should be appreciated that these examples are non-limiting and task element graph 622a may depict a time spent on different tasks in any manner.

Task elements 622 can further include a blockers element 622b indicating a breakdown of tasks that are blocking or being blocked among a team (or individual). In one non-limiting example, one or more employees may work with different task management applications where different tasks can be associated with and/or assigned to different individuals. A corporation could assign various tasks to a manager, and the manager can delegate various tasks to different members of a team. For example, a manager may be assigned a main task and then the manager can assign sub-tasks to different team members. If a team member does not complete a sub-task within a given period of time (thus causing the manager to be unable to meet a deadline for the main task), the main task may be blocked by the sub-task. Likewise, the sub-task, in turn, could be blocking the main task from completion. Blockers element 622b can provide a graph (e.g., line graph) having a quantity (e.g., number of hours) along one axis and a time unit along another axis. Different colors in each line can depict a summary of items that are blocking, or items that are being blocked.

Task elements 622 may further include project time elements 622c providing indication of most time spent by project for one or more employees. In the example of FIG. 6B, project time elements 622c can include a listing of different projects along with a time amount (e.g., in hours and minutes) for which a team has spent on a project. Project time elements 622c can further include an indication of increase/decrease in time spent by showing a percentage and/or graphical indicator (e.g., up/down arrow) for each item. The items shown in task elements 622 are of course non-limiting and the technology described herein envisions any variety of information displayable in association with task elements 622.

It should be appreciated that some of the elements described and shown herein include additional indicators (e.g., application “A,” application “B,” application “C”) related to the various software applications for generating the data shown in the element. These software applications could include any of the applications described herein (e.g., e-mail, video conference, project management) and the graphical indicators can easily show which applications various data has been extracted and processed in order to generate the information shown in each element. For example, elements 622a-c in task elements 622 include an application icon corresponding to a project management application used to generate the information provided in elements 622a-c.

FIG. 6C shows another non-limiting example user interface 600 depicting further details of the team view. In the example of FIG. 6C, user interface 600 includes further information in body portion 620 of various components associated with the work models. FIG. 6C further shows a projects-by-size element 623, a daily meetings element 624, meetings time element 625, a projected stress element 626, and a time percentage element 627. It should be appreciated that projects-by-size element 623 can include information associated with different projects as well as the time spent on each project. In the example of FIG. 6C, projects-by-size element 623 includes a bar graph having a time quantity (e.g., in hours) on a first axis and a project identifier on a second axis. The bar graph elements can depict a measurement of planned time on a project as well as real time spent on a project. In one non-limiting example, the planned time on a project could correspond to the amount of time set by a project management system for planning a total amount of time for working on a project, where the real time spent could correspond to the actual number of hours logged by a user on a project. The size of each bar graph could correspond to the amount of time (e.g., in hours) the team has planned (or spent) on a given project. It should be appreciated that the planned time may be represented as a single bar graph where the real time spent may be represented also as a corresponding single bar graph (e.g., positioned next to each other). Alternatively, the planned time and real time spent may be shown together in a single bar graph (e.g., with different colors indicating an amount).

Daily meetings element 624 can include information indicating an amount of time during a given week the individual/team/company has spent in meetings. In the example shown in FIG. 6C, daily meetings element 624 includes a bar graph having a time quantity on a first axis (e.g., in hours) and a day indication (e.g., Monday, Tuesday, Wednesday) along a second axis. A size of the bar graph for each day could indicate how many hours are spent in daily meeting(s). Moreover, the bar graph could include an individual graph for each company/team/individual. FIG. 6C shows an individual bar graph in daily meetings element 624 for the company and an individual bar graph for the team. The bar graphs in daily meetings element 624 are displayed next to each other. But, it should be appreciated that the bar graphs can be shown as a single graph (e.g., with different colors distinguishing between the company and team).

Meetings time element 625 includes metrics identifying meeting allocation above a certain time threshold within a given period of time. Meetings time element 625 in FIG. 6C specifically provides a breakdown of the amount of time the company and/or team spends in meetings over one hour. In the example of FIG. 6C, meetings time element 625 provides a bar graph showing a percentage along a first axis and a unit of time (e.g., in weeks) along a second axis, where the line graph shows the percentage of time for the company and team in meetings over one hour during each of the weeks. As can be seen in FIG. 6C, some of the elements include a brief indicator as to how much change has occurred at a given point in time in association with the element. For example, daily meetings element 624 includes an indicator showing an 83% drop in daily meetings, while meetings time element 625 includes an indicator showing a 92% drop in meetings over one hour. Such indication can further provide the user with a quick summary as to where the productivity may be increasing or decreasing with respect to a given productivity category.

Projected stress element 626 includes information predicting the level of stress for the individual/team/company in the user interface 600. In the example of FIG. 6C, projected stress element 626 provides a line graph with a stress indication range on a first axis (e.g., between “low” and “high”) and a time unit along a second axis (e.g., in weeks). Each line in the line graph could correspond to any of an individual, team, company, and/or industry where the levels of the line graph over time indicate the projected stress. It should be appreciated that the information provided in projected stress element 626 can be obtained from the various data associated with each work model. The information in projected stress element 626 can be further processed using various machine learning techniques (which could include continual subjective user feedback) to “predict” the stress level associated with an individual or group. For example, system 1 could use information related to how many meetings a user attends in a given week, along with any variety of historical data, to “predict” the user's overall stress level for a given week. This example is of course non-limiting and the technology described herein envisions any variety of techniques for predicting stress levels of an individual and/or group.

Time percentage element 627 can include information indicating a general percentage of time spent within different work models for the individual and/or group. In the example shown in FIG. 6C, time percentage element 627 shows the percentage of time the team spends in each work model. Time percentage element 627 can include a circle graph showing the associated portion of time in each portion of the circle graph. For example, FIG. 6C depicts the team spending 45% of time in tasks with 55% of time spent in meetings, where the portions of the circle graph associated with each are respectively colored. The circle graph can show, in each color, an approximate proportion within the circle itself based on the overall percentage for each bucket. As can be seen in the example of FIG. 6C, the circle graph in time percentage element 627 shows the meetings item consuming slightly more than half of the circle as meetings takes up slightly over half of the time (i.e., at 55%). It should be appreciated that many of the elements shown in user interface 600 will include information from each work model, while some elements may include information from multiple work models (e.g., as an aggregation of multiple areas from different work models). As an example, time percentage element 627 depicts data from tasks and meetings (and can further include data from any of the other work models).

FIG. 6D shows another non-limiting example user interface 600 depicting further details of the team view. In the example of FIG. 6D, user interface 600 further includes task tracking element 628 and communication element 629. It should be appreciated that task tracking element 628 may include information indicating how each individual and/or group is performing with respect to keeping various tasks on schedule. In one non-limiting example, task tracking element 628 can include a bar graph having a listing of individuals and/or groups along a first axis, and a percentage value alone a second axis. The size of each bar in the bar graph can indicate a percent of how “on track” each individual and/or group is with respect to their overall tasks. In the example shown in FIG. 6D, “Frank” is most “on track” at about 100% where “Dan” and “Arsen” are least “on track” at about 0%. The information shown in task tracking element 628 can be obtained based on task management data (e.g., taken from task model data) where the indication in each bar can relate to a proportion of a number of tasks completed (or still “on track”) to a number of tasks pending (or not “on track”).

Task tracking element 628 can include additional graphical and/or textual information providing certain “high level” indication as to how the group is performing with respect to their overall tasks. In the example shown in FIG. 6D, task tracking element 628 further includes an indication of postponed due dates with text showing 20% and a green “up arrow” noting that the postponed due dates have increased 20%. Task tracking element 628 further includes an indication of overdue tasks and blocked tasks where overdue tasks contain text showing 22% and a red “down arrow” indicating a drop of 22% in overdue tasks (with zero percent blocked tasks). These examples are of course non-limiting and the technology described herein envisions any variety of methods for depicting task management data.

Communication element 629 can include information identifying how much and what type of communication is being carried out by the individual and/or group. In one non-limiting example, communication element 629 can include a bar (or line) graph with quantity indicator along a first axis and a time unit along a second axis (e.g., in weeks) where different bars/lines can indicate how much an individual and/or group spends in a type of communication. For example, one bar could indicate how much a given individual and/or group spends in calls, another bar could indicate e-mail, and yet another bar could indicate instant messaging. Such data could be obtained, for example, from the communication data work model (e.g., from communication applications such as e-mail, instant messaging, video conferencing, etc.).

FIG. 6E shows another non-limiting example user interface 600 depicting aspects of an individual view. Various elements of the individual view of user interface 600 contain information similar to that shown in the team view (e.g., as illustrated in FIGS. 6A-D) but specific to a particular individual. It should be appreciated that selection of different elements in the user interface 600 can allow user interface 600 to switch between the team view to an individual view (e.g., view selection 611). For example, a graphical element (e.g., a menu) can be provided allowing a user to select between showing any of the individual, team, company, and/or industry views.

In the example shown in FIG. 6E, individual view of user interface 600 includes a similar header and body portions (e.g., as shown in FIG. 6A) with various elements that are similarly found in the user interface 600 shown in FIGS. 6A-D. FIG. 6E, as a non-limiting example, shows overview elements 631 having “call to action” items alerting a user of the most relevant items needing attention. Similar to overview elements 621 in FIG. 6A, overview elements 631 include different rectangular objects having different overview “snippets” associated with productivity. Overview elements 631 could include indications as to how productivity has risen (or dropped) during a particular time scale for an individual. For example, overview elements 631 could include a rectangular object indicating a “drop in meetings that are too long” along with a graphical indicator (e.g., “down arrow,” “up arrow”) and a percentage associated with the rise or drop in productivity. FIG. 6E shows additional rectangular objects associated with a rise or decline projected stress and workload. It should be appreciated that these examples are of course non-limiting and the technology described herein envisions any variety of objects that could be displayed in association with overview elements 631.

FIG. 6E further shows various productivity elements 632 containing individual elements depicting individual productivity. Many of the individual elements shown in productivity elements 632 is similar to those depicted in FIGS. 6B-D, though for an individual rather than a group. For example, productivity elements 632 includes a similar communications element (e.g., as shown in communications element 628), daily meetings element (e.g., as shown in daily meetings element 624), and meetings time element (e.g., as shown in meetings time element 625). The information depicted in the elements of productivity elements 632 is similar to those shown in FIGS. 6A-D though, again, based on individual productivity (as opposed to group/team productivity). It should be appreciated that some of the elements in productivity element 632 may also depict productivity information associated with a group (as well as the individual). For example, daily meetings element and meetings time element (of productivity element 632) include metrics associated with both the individual as well as the company and team. Such information can be useful in showing a comparative analysis as to how the individual is performing relative to a group (e.g., team/company/industry).

FIG. 6F shows another non-limiting example user interface 600 depicting aspects of a company view. Various elements of the company view of user interface 600 contain information similar to that shown in the team and individual view(s) (e.g., as illustrated in FIGS. 6A-E) but specific to a particular company. In the example shown in FIG. 6F, company view of user interface 600 includes a similar header and body portions (e.g., as shown in FIG. 6A) with various elements that are similarly found in the user interface 600 shown in FIGS. 6A-E. FIG. 6F, as a non-limiting example, shows overview elements 641 having “call to action” items alerting a user of the most relevant items needing attention. Similar to overview elements 621 in FIG. 6A (and overview elements 631 of FIG. 6E), overview elements 641 include different rectangular objects having different overview “snippets” associated with productivity. Overview elements 641 could include indications as to how productivity has risen (or dropped) during a particular time scale for a company. For example, overview elements 641 could include a rectangular object indicating a “drop in projected stress” along with a graphical indicator (e.g., “down arrow,” “up arrow”) and a percentage associated with the rise or drop in productivity. FIG. 6F shows additional rectangular objects associated with a rise or decline in workload. It should be appreciated that these examples are of course non-limiting and the technology described herein envisions any variety of objects that could be displayed in association with overview elements 641.

FIG. 6F further shows various productivity elements 642 containing individual elements depicting individual productivity. Many of the individual elements shown in productivity elements 642 is similar to those depicted in FIGS. 6B-E, though for a company rather than a team or individual. For example, productivity elements 642 includes a similar communications element (e.g., as shown in communications element 628) and daily meetings element (e.g., as shown in daily meetings element 624). The information depicted in the elements of productivity elements 642 is similar to those shown in FIGS. 6B-E though, again, based on company productivity (as opposed to individual or team productivity). It should be appreciated that some of the elements in productivity element 642 may also depict productivity information associated with a group (as well as the individual). For example, daily meetings element (of productivity element 642) could include metrics associated with both the individual as well as the company and team.

Productivity element 642 may also include a focus time element depicting information associated with areas of focus for a company over a given period of time. As a non-limiting example, focus time element of productivity element 642 may include a graph having a percentage amount along a first axis with a time amount (e.g., in weeks) along a second axis. Different elements of the graph in focus time element may include an indication (e.g., for individual, team, company, and/or industry) showing a percentage of different areas of focus over a given period of time. The areas of focus could include the general work models (e.g., task, communication, meeting) or could include further details within the work models (e.g., call, e-mail, instant messaging of communications work model). These examples are of course non-limiting and the technology described herein envisions and variety of information that could be shown in focus time elements displayed in user interface 600.

It should be appreciated that the elements found in user interface 600 can include any variety of element/modules providing information associated with individual and/or group productivity. As a non-limiting example, user interface 600 could further include a workload element depicting workload amounts (e.g., as estimated across multiple different software applications). The workload amounts could be graphically depicted (e.g., using a bar graph) where a percentage value (e.g., percentage of total workload) can be shown along a first axis with a time unit (e.g., in weeks) along a second axis. Different sizes of the bars in the bar graph for workload elements could indicate a percentage of workload associated with an individual or group for the particular period of time. It should be appreciated that the examples shown in user interface 600 are non-limiting and the technology described herein envisions any variety of methods for showing progress for the individual/group including, but not limited to, pie charts, bar graphs, line graphs, and/or heat maps.

While not depicted in the examples of FIGS. 6A-F, user interface 600 can provide any variety of views including an industry view. In one non-limiting example, the industry view may show elements similar to those presented in the individual, team, and/or company view, but relevant to an industry as a whole. For example, the industry view may show metrics across multiple companies in a particular industry (e.g., insurance industry, airline industry). These examples are of course non-limiting and the technology described herein envisions any variety of information that can be presented in user interface 600.

FIG. 7 shows a non-limiting example block diagram of a hardware architecture for the system 1200. In the example shown in FIG. 7, the client device 1210 communicates with a server system 1250 via a network 1240. The network 1240 could comprise a network of interconnected computing devices, such as the internet. The network 1240 could also comprise a local area network (LAN) or could comprise a peer-to-peer connection between the client device 1210 and the server system 1250. As will be described below, the hardware elements shown in FIG. 7 could be used to implement the various software components and actions shown and described above as being included in and/or executed at the client device 1210 and server system 1250.

In some embodiments, the client device 1210 (which may also be referred to as “client system” herein) includes one or more of the following: one or more processors 1212; one or more memory devices 1214; one or more network interface devices 1216; one or more display interfaces 1218; and one or more user input adapters 1220. Additionally, in some embodiments, the client device 1210 is connected to or includes a display device 1230. As will explained below, these elements (e.g., the processors 1212, memory devices 1214, network interface devices 1216, display interfaces 1218, user input adapters 1220, display device 1230) are hardware devices (for example, electronic circuits or combinations of circuits) that are configured to perform various different functions for the computing device 1210.

In some embodiments, each or any of the processors 1212 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1212 uses an instruction set architecture such as x86 or Advanced RISC Machine (ARM).

In some embodiments, each or any of the memory devices 1214 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1212). Memory devices 1214 are examples of non-volatile computer-readable storage media.

In some embodiments, each or any of the network interface devices 1216 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces 1218 is or includes one or more circuits that receive data from the processors 1212, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 1230, which displays the image data. Alternatively or additionally, in some embodiments, each or any of the display interfaces 1218 is or includes, for example, a video card, video adapter, or graphics processing unit (GPU).

In some embodiments, each or any of the user input adapters 1220 is or includes one or more circuits that receive and process user input data from one or more user input devices (not shown in FIG. 7) that are included in, attached to, or otherwise in communication with the client device 1210, and that output data based on the received input data to the processors 1212. Alternatively or additionally, in some embodiments each or any of the user input adapters 1220 is or includes, for example, a PS/2 interface, a USB interface, a touchscreen controller, or the like; and/or the user input adapters 1220 facilitates input from user input devices (not shown in FIG. 7) such as, for example, a keyboard, mouse, trackpad, touchscreen, etc. . . . .

In some embodiments, the display device 1230 may be a Liquid Crystal Display (LCD) display, Light Emitting Diode (LED) display, or other type of display device. In embodiments where the display device 1230 is a component of the client device 1210 (e.g., the computing device and the display device are included in a unified housing), the display device 1230 may be a touchscreen display or non-touchscreen display. In embodiments where the display device 1230 is connected to the client device 1210 (e.g., is external to the client device 1210 and communicates with the client device 1210 via a wire and/or via wireless communication technology), the display device 1230 is, for example, an external monitor, projector, television, display screen, etc. . . . .

In various embodiments, the client device 1210 includes one, or two, or three, four, or more of each or any of the above-mentioned elements (e.g., the processors 1212, memory devices 1214, network interface devices 1216, display interfaces 1218, and user input adapters 1220). Alternatively or additionally, in some embodiments, the client device 1210 includes one or more of: a processing system that includes the processors 1212; a memory or storage system that includes the memory devices 1214; and a network interface system that includes the network interface devices 1216.

The client device 1210 may be arranged, in various embodiments, in many different ways. As just one example, the client device 1210 may be arranged such that the processors 1212 include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the client device 1210 may be arranged such that: the processors 1212 include two, three, four, five, or more multi-core processors; the network interface devices 1216 include a first network interface device that implements Ethernet and a second network interface device that implements WiFi and/or Bluetooth; and the memory devices 1214 include a RAM and a flash memory or hard disk.

Server system 1250 also comprises various hardware components used to implement the software elements for server system 200 of FIG. 2. In some embodiments, the server system 1250 (which may also be referred to as “server device” herein) includes one or more of the following: one or more processors 1252; one or more memory devices 1254; and one or more network interface devices 1256. As will explained below, these elements (e.g., the processors 1252, memory devices 1254, network interface devices 1256) are hardware devices (for example, electronic circuits or combinations of circuits) that are configured to perform various different functions for the server system 1250.

In some embodiments, each or any of the processors 1252 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1252 uses an instruction set architecture such as x86 or Advanced RISC Machine (ARM).

In some embodiments, each or any of the memory devices 1254 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1252). Memory devices 1254 are examples of non-volatile computer-readable storage media.

In some embodiments, each or any of the network interface devices 1256 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In various embodiments, the server system 1250 includes one, or two, or three, four, or more of each or any of the above-mentioned elements (e.g., the processors 1252, memory devices 1254, network interface devices 1256). Alternatively or additionally, in some embodiments, the server system 1250 includes one or more of: a processing system that includes the processors 1252; a memory or storage system that includes the memory devices 1254; and a network interface system that includes the network interface devices 1256.

The server system 1250 may be arranged, in various embodiments, in many different ways. As just one example, the server system 1250 may be arranged such that the processors 1252 include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the server system 1250 may be arranged such that: the processors 1252 include two, three, four, five, or more multi-core processors; the network interface devices 1256 include a first network interface device that implements Ethernet and a second network interface device that implements WiFi and/or Bluetooth; and the memory devices 1254 include a RAM and a flash memory or hard disk.

As previously noted, whenever it is described in this document that a software module or software process performs any action, the action is in actuality performed by underlying hardware elements according to the instructions that comprise the software module. Consistent with the foregoing, in various embodiments, each or any combination of the client device 210 or the server system 220, each of which will be referred to individually for clarity as a “component” for the remainder of this paragraph, are implemented using an example of the client device 1210 or the server system 1250 of FIG. 7. In such embodiments, the following applies for each component: (a) the elements of the client device 1210 shown in FIG. 7 (i.e., the one or more processors 1212, one or more memory devices 1214, one or more network interface devices 1216, one or more display interfaces 1218, and one or more user input adapters 1220) and the elements of the server system 1250 (i.e., the one or more processors 1252, one or more memory devices 1254, one or more network interface devices 1256), or appropriate combinations or subsets of the foregoing, are configured to, adapted to, and/or programmed to implement each or any combination of the actions, activities, or features described herein as performed by the component and/or by any software modules described herein as included within the component; (b) alternatively or additionally, to the extent it is described herein that one or more software modules exist within the component, in some embodiments, such software modules (as well as any data described herein as handled and/or used by the software modules) are stored in the respective memory devices (e.g., in various embodiments, in a volatile memory device such as a RAM or an instruction register and/or in a non-volatile memory device such as a flash memory or hard disk) and all actions described herein as performed by the software modules are performed by the respective processors in conjunction with, as appropriate, the other elements in and/or connected to the client device 1210 or server system 1250; (c) alternatively or additionally, to the extent it is described herein that the component processes and/or otherwise handles data, in some embodiments, such data is stored in the respective memory devices (e.g., in some embodiments, in a volatile memory device such as a RAM and/or in a non-volatile memory device such as a flash memory or hard disk) and/or is processed/handled by the respective processors in conjunction, as appropriate, the other elements in and/or connected to the client device 1210 or server system 1250; (d) alternatively or additionally, in some embodiments, the respective memory devices store instructions that, when executed by the respective processors, cause the processors to perform, in conjunction with, as appropriate, the other elements in and/or connected to the client device 1210 or server system 1250, each or any combination of actions described herein as performed by the component and/or by any software modules described herein as included within the component.

The hardware configurations shown in FIG. 7 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 7, (e) via other hardware arrangements, architectures, and configurations, and/or via combinations of the technology described in (a) through (e).

### Technical Advantages of Described Subject Matter

The technology described herein also allows for efficient storage and processing of data and improves the system's ability to display information and interact with a user. In particular, the system can process large volumes of data elements associated with application usage and efficiently store the same in a database managed by the system so that the data can be used to generate a user interface. In doing so, the system efficiently stores, organizes, and manages large volumes of data by breaking the data down into understandable components that are used in fast and efficient generation of a display presenting the data. More specifically, the system enables more efficient storage of data in the memory of the system thus providing an enhanced computer memory system.

The technology described herein also provides a user interface that advantageously conveys certain information to a user. For example, the technology includes a user interface having a variety of views where each view conveys different information related to a single user (or a team of users) and how user(s) productivity level associated with each application. In doing so, the system improves the overall human-computer interaction for users of the system.

### Selected Definitions

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

### Further Applications of Described Subject Matter

Although a number of references are made in this document to web applications, it should be understood that the features described herein may also be used, in various embodiments, in the context of other types of applications such as applications that are deployed/installed as binaries on client systems.

Although process steps, algorithms or the like, including without limitation with reference to FIGS. 1-7, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed.

Moreover, it is not necessary for a device or method to address each and every problem sought to be solved by the present invention, for it to be encompassed by the invention. No embodiment, feature, element, component, or step in this document is intended to be dedicated to the public.

While the technology has been described in connection with what is presently considered to be an illustrative practical and preferred embodiment, it is to be understood that the technology is not to be limited to the disclosed embodiment, but on the contrary, is intended to cover various modifications and equivalent arrangements.

1. A system for generating a common application dashboard, the system comprising:
a server system, comprising:
a processor; and
a memory configured to store computer readable instructions that, when executed by the processor, cause the server system to:
obtain application data for one or more applications associated with a first user;
analyze the application data to determine if the application data corresponds to one or more work models;
assign portions of the application data to the one or more work models based on the analysis; and
generate user interface data based on the portions of the application data assigned to the one or more work models, wherein
the user interface data includes a first view and a second view associated with the one or more work models;
the first view comprises an individual dashboard; and
the second view comprises a team dashboard, and
a client system, comprising:
a processor; and
a memory configured to store computer readable instructions that, when executed by the processor, cause the client system to:
obtain the user interface data from the server system;
render the user interface data to generate a user interface for display by the client system.

2. The system of claim 1, wherein the individual dashboard includes:
a first portion that includes one or more action elements highlighting changes in productivity, of the first user, in association with the one or more work models.

3. The system of claim 2, wherein the individual dashboard further includes:
a second portion that includes one or more productivity metrics elements showing metrics data associated with the productivity of the first user.

4. The system of claim 1, wherein the team dashboard includes:
a first portion that includes one or more action elements highlighting changes in productivity, of a plurality of users, in association with the one or more work models.

5. The system of claim 4, wherein the team dashboard further includes:
a second portion that includes one or more productivity metrics elements showing metrics data associated with the productivity of the plurality of users.

6. The system of claim 1, wherein the first view includes a portion showing stress metrics associated with the first user.

7. The system of claim 1, wherein the second view includes a portion showing stress metrics associated with a plurality of users.

8. The system of claim 1, wherein the one or more work models include any of task model, a document model, a communication model, a time model, and/or a meeting model.

9. The system of claim 1, wherein the application data includes JavaScript Object Notation (JSON) data for the one or more applications, and the server system is further configured to:
parse the JSON data for data elements associated with the one or more work models;
extract the data elements from the JSON data; and
store the extracted data elements in a database memory of the system.

10. The system of claim 9, wherein the server is further configured to store the data elements in a database memory associated with each work model from the one or more work models.

11. A method for generating a common application dashboard, the method comprising:
at an information processing system having at least one processor:
obtaining application data for one or more applications associated with a first user;
analyzing the application data to determine if the application data corresponds to one or more work models;
assigning portions of the application data to the one or more work models based on the analysis; and
generating user interface data based on the portions of the application data assigned to the one or more work models, wherein
the user interface data includes a first view and a second view associated with the one or more work models;
the first view comprises an individual dashboard; and
the second view comprises a team dashboard.

12. The method of claim 11, wherein the individual dashboard includes:
a first portion that includes one or more action elements highlighting changes in productivity, of the first user, in association with the one or more work models.

13. The method of claim 12, wherein the individual dashboard further includes:
a second portion that includes one or more productivity metrics elements showing metrics data associated with the productivity of the first user.

14. The method of claim 11, wherein the team dashboard includes:
a first portion that includes one or more action elements highlighting changes in productivity, of a plurality of users, in association with the one or more work models.

15. The method of claim 14, wherein the team dashboard further includes:
a second portion that includes one or more productivity metrics elements showing metrics data associated with the productivity of the plurality of users.

16. A system for generating a common application dashboard, the system comprising:
a processor; and
a memory configured to store computer readable instructions that, when executed by the processor, cause the server system to:
obtain application data for one or more applications associated with a first user;
analyze the application data to determine if the application data corresponds to one or more work models;
assign portions of the application data to the one or more work models based on the analysis; and
generate user interface data based on the portions of the application data assigned to the one or more work models, wherein
the user interface data includes a first view and a second view associated with the one or more work models;
the first view comprises an individual dashboard; and
the second view comprises a team dashboard.

17. The system of claim 16, wherein the individual dashboard includes:
a first portion that includes one or more action elements highlighting changes in productivity, of the first user, in association with the one or more work models.

18. The system of claim 17, wherein the individual dashboard further includes:
a second portion that includes one or more productivity metrics elements showing metrics data associated with the productivity of the first user.

19. The system of claim 16, wherein the team dashboard includes:
a first portion that includes one or more action elements highlighting changes in productivity, of a plurality of users, in association with the one or more work models.

20. The system of claim 19, wherein the team dashboard further includes:
a second portion that includes one or more productivity metrics elements showing metrics data associated with the productivity of the plurality of users.
